(19) United States
(12) Patent Application Publication
(10) Pub. No.: US 2006/0143956 A1
(43) Pub. Date: Jul. 6, 2006

(54) Public and private road safety and advertising medium

(76) Inventors: Billy S. Star, Studio City, CA (US); Courtney Rae Ross-Tait, Studio City, CA (US)

Correspondence Address: FULWIDER PATTON, 6060 CENTER DRIVE, 10TH FLOOR, LOS ANGELES, CA, 90045, US

(21) Appl. No.: 11/081,800

(22) Filed: Mar. 16, 2005

Related U.S. Application Data
(60) Provisional application No. 60/553,822, filed on Mar. 16, 2004.
(60) Provisional application No. 60/569,894, filed on May 10, 2004.

(51) Int. Cl. G09F 7/00; G09F 7/12

(52) U.S. Cl. 40/584; 40/594

(57) ABSTRACT

The billboard alternative, which permits the removable attachment of a sign-bearing billboard to the pavement, roads, parking garages, bikeways, walkways, sidewalks, etc. for use by public and private corporations, governmental and non-governmental organizations, and individuals to advertise, promote, and inform drivers safely and effectively of anything that can be advertised. The billboard alternative uses a new, possibly porous material that adheres to the surface using an easily removable, extraordinarily durable adhesive. It allows for quick advertisement logo changes and is safe because the material is slip resistant, quick drying, and flush with the pavement.

### CROSS-REFERENCE TO RELATED APPLICATION(S)

This application claims the benefit of U.S. Provisional Patent Application No. 60/553,822, filed Mar. 16, 2004 and 60/569,894, filed May 10, 2004 both entitled PUBLIC AND PRIVATE ROAD SAFETY AND ADVERTISING MEDIUM, the disclosures of both of which are incorporated by reference.

### BACKGROUND

This invention is related to advertising and safety, specifically to placing advertising on public and private roads, parking lots, bikeways, walkways, and pedestrian sidewalks both indoor and outdoor to increase driver safety, adding a new marketing medium to stimulate economical growth, and increasing government budgets city, state and nationally without taxation for road repair, etc. through established fees, licenses, and profit sharing. Everywhere you look there is advertising. Most all private corporations, public corporations, governments, etc. use advertising for a variety of reasons including boosting sales, giving the consumer information about a product, scenario, etc., and/or sending a specific message. In recent years, forms of advertising have grown rapidly due to the Internet, yet these forms only reach a niche market and they do not increase the general safety of the individuals around them. In reality, finding an advertising source that increases safety is not easy to find.

There are many advertisements directed to an individual while driving, biking, etc. Billboards have long been used as a form of advertising but have fallen short in many ways including the limited availability of space for advertising billboards as well as the need to glance off of the road to read them. Billboards, however, do not allow for maximum driver safety because the driver is forced to look off the road instead of straight ahead.

### SUMMARY

Aspects of the invention institute an infrastructure as well as the product (material, adhesive, etc) to begin advertising on public and private pavements, roads, parking garages, bikeways, walkways, etc. both indoor and outdoor. In some aspects these advertisements are centered in the lane and/or walkway, are non-slip, are flush with the surface it is adhered to and can be removed, changed, and upgraded efficiently and affordably. Public and private corporations, governments, groups, individuals, etc. can license through either the city or the private owner of the given advertisements location to advertise under contract for a certain time length. Driving while reading advertisements will become much safer because it allows the driver to remain a straight forward sight line, increasing reaction time for unforeseeable driving issues. There will be economical growth based on this creation of a new advertising medium for sales representatives to push, artists to design, engineers to remove and/or replace, scientists and chemists to create adhesives and solvents, etc. Governments will see an increase in revenue from fees, licenses, and profit sharing which can be used to better our streets, law enforcement, safety, and countless other agencies and departments.

In some aspects the invention provides an advertising medium, comprising an application and material that is both non-slip and flush with the surface in which it is adhered to; a material that is printed with a public or private corporation, governmental or non-governmental organization, individual, etc's. advertisement, logo, reminder, etc.; a material with the ability to use all of the colors, shapes (including 3-D artwork), and sizes (although a standard size is issued as a default in most advertising mediums); the material uses an adhesive that is not only durable, but fast drying and easily dissolved by its solvent for removal; a much safer way to advertise, by placing the advertisement on the pavement, roads, parking garages, bikeways, walkways, sidewalks (indoor and/or outdoor) etc. centered in the lane straight ahead of the driver; and whereby (a) a driver will no longer have to glance off the road to the right or left to view billboard advertisements, and/or information on rest stops, gas, etc., the driver will maintain a straight forward sight line allowing for maximum safety while operating a vehicle, resulting in fewer accidents, swerving, etc.; reduction in insurance costs, loss of life, injury reduction, creation of new revenue sources, (b) the advertisement is also both slip resistant and flush with the surface it is adhered to for maximum safety, (c) the advertisement is non-peeling and non-fading for the length of the average life span which is important for the cost to benefit ratio for advertisers, with upkeep performed in some embodiments; (e) all governmental budgets both city, state and nationally will increase from fees, licenses and revenue sharing from the advertisements; ballot measures to earmark use of funds allows for voter participation; more monies for streets, schools, law enforcement, etc., (f) better streets due to more governmental monies as well as advertisers granting money for specific repairs in the location of their advertisement, and (g) governments and politicians will gain higher approval ratings.

### DRAWINGS

FIG. 1 is an aerial view of a typical billboard sign advertisement.

FIG. 2 is an aerial view of an advertising billboard alternative constructed and governed in accordance with the invention.

FIG. 3 is an aerial view of a typical corner strip mall with a “Don't Forget to Vote This Tuesday!” billboard alternative.

FIG. 4 is a side view, close-up, of how the billboard alternative interacts with the surface it is placed on, showing that is nearly flush with the surface.

FIG. 5 is a closer look at the pores of the billboard alternative that will allow for easy solvent/solution interaction to speed the removal process.

FIG. 6 shows an aerial view of an exemplary billboard alternative placed along the boardwalk at the beach.

FIG. 7 is an aerial view of a billboard alternative as seen from a video camera at a large event, ie. Super Bowl, World Series, etc.

FIG. 8 is a lateral view of a billboard alternative inside of an airport terminal.

FIG. 9 is a magnified side view of a billboard alternative showing an overlay of reflective material.

FIG. 10 is a magnified side view showing advertisement material pressed up against a reflective overlay.

FIG. 11 is a flow diagram of a process in accordance with aspects of the invention.

### DETAILED DESCRIPTION

The billboard alternative is placed on the road and/or walkways both indoor and outdoor, or rooftops, which have plenty of free space for new advertisements as well as maintains the drivers' safety. The billboard alternative is, in several embodiments, a large advertisement, made of a non-slip, very thin material, which is adhered to the ground by a very strong, yet easily removable adhesive. These properties are ideal because it allows the billboard alternative to be largely flush with the ground, and easy to drive, bike, walk, etc. over. Similar in some ways to a giant sticker, the billboard alternative is easily removable which is unlike the properties of a sticker, yet is durable, non-peeling and/or non-lifting (with appropriate upkeep in some embodiments) to allows rugged abuse by cars, SUV's, motorcycles, street sweepers, trash trucks, bicycles, pedestrians, etc. In some embodiments the material is porous, allowing a solvent to easily get underneath the billboard alternative to dissolve the adhesive whenever it need be done.

There are few inventions that address both advertisement and safety concurrently as does the billboard alternative. There are many smaller forms of driver advertising such as bumper stickers, vehicle billboards, license plate frames, etc., but these forms, although safe because they keep the driver focused straight ahead, do not meet the needs of advertisers. They are small, usually not easily changed or removed, and do not have the added benefit of putting money into governmental budgets. The Vehicle Billboard, U.S. Pat. No. 5,878,516 does permit interchangeable advertising billboards and usually maintains drivers safety, but again, they have limited space for advertisers and do not garner funds for streets and other governmental departments. (Allocations of these monies will probably be voted on as a referendum).

Safety has always been a big issue in our society. As much as we are consumers, we like to feel safe while doing it. There have been few advertising strategies that cause the consumer to feel safer. U.S. Pat. No. 6,511,214 to Parsons, et al (2001) shows a miniature LED flashlight which they say can be used as a keychain, and many marketing companies use as imprinted merchandise. If miniature flashlight keychains, imprinted with a Company's logo are handed out, this can be considered a form of advertising that increases safety. There are other such items such as imprinted whistles, backing-up mirrors, imprinted pepper spray, etc. Still these advertising methods are not nearly as effective as the billboard alternative for safety, and advertisers would much rather have a larger, longer lasting, and durable billboard alternative, which can reach many more people. The billboard alternative advertising reaches everyone -from licensed drivers, to bicyclists, pedestrians, passengers, etc.

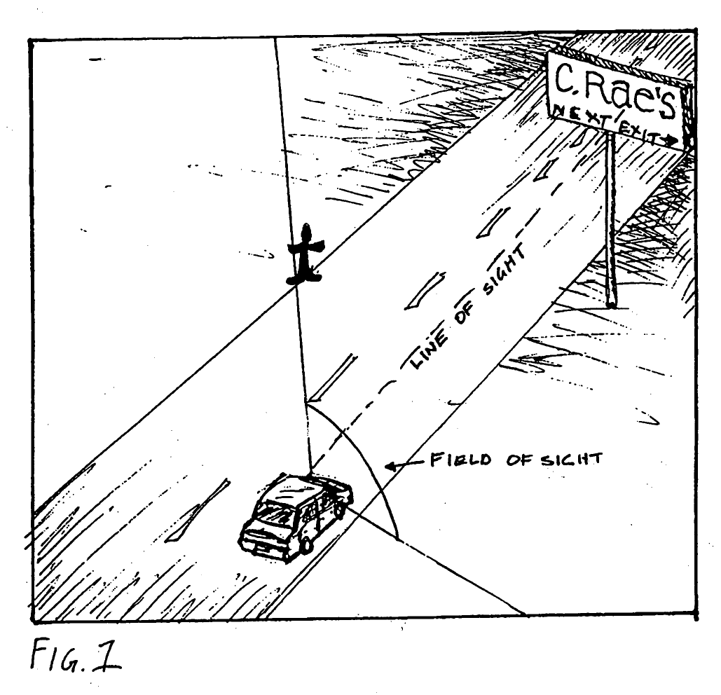

FIG. 1 is an aerial view of a car traveling down the road. There is a typical billboard advertisement sign on the right side. (Shown here as a corporation logo) The driver glances to the right to read the sign. The driver is not looking straight ahead, therefore does not see the child chasing the ball ahead on the left with enough time to react.

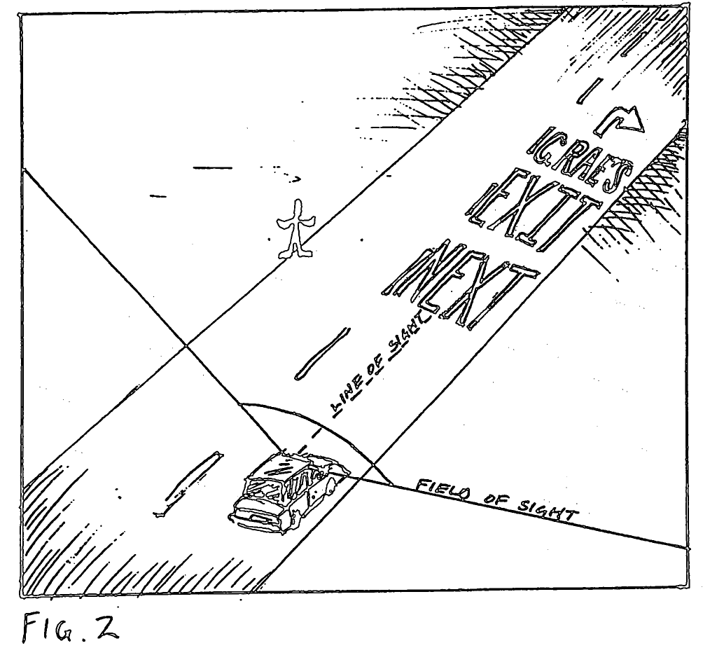

FIG. 2 is an aerial view of the same car from FIG. 1 traveling down the road. There is a typical billboard alternative, the safer, billboard alternative. (Shown here as the corporation logo) The driver's sight remains straight forward, allowing for maximum safety while driving.

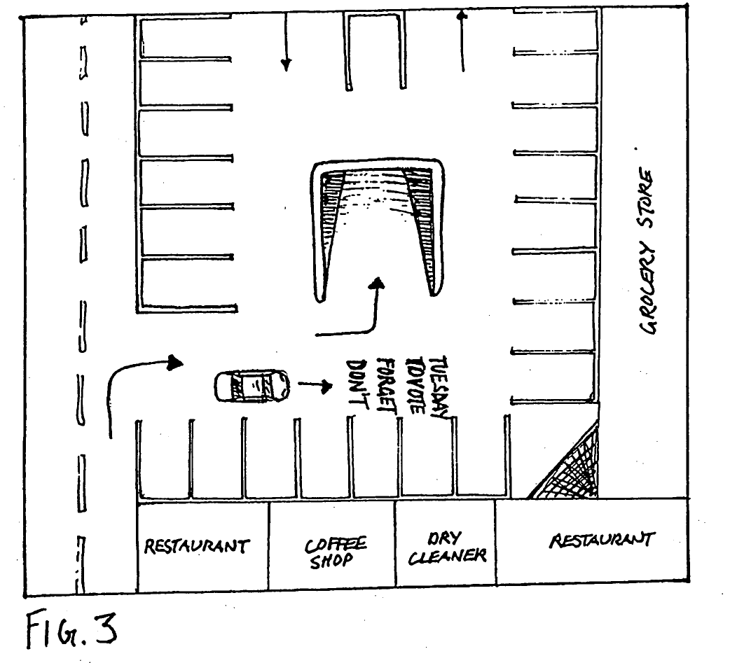

FIG. 3 is an aerial view of one of the many alternative application areas advertisers will fight over. Shown here is a typical corner strip mall with a reminder message from the city reading “Don't Forget to Vote This Tuesday”. This sketch shows how, both public and private industries benefit from the billboard alternative.

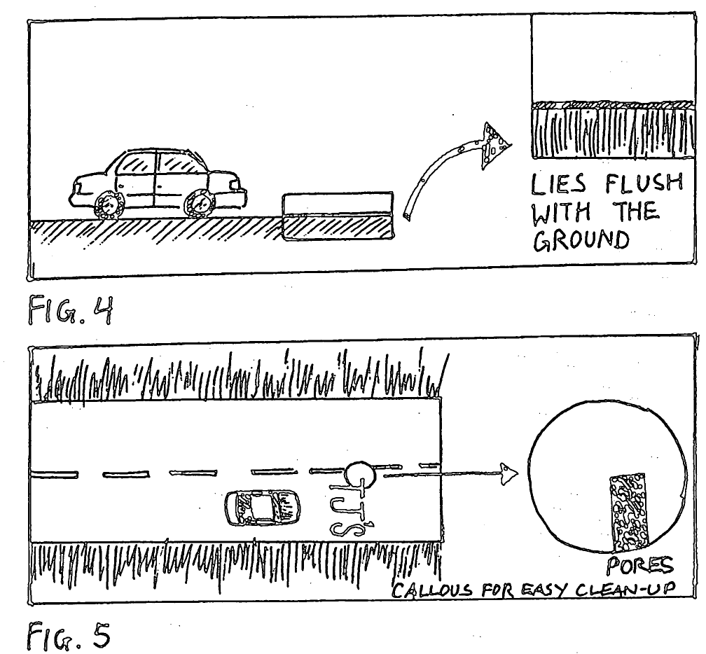

FIG. 4 is a lateral, side view, magnified showing a typical billboard alternative, and how it interacts with the surfaces it is applied to. Notice how the billboard alternative is nearly completely flush with the surface.

FIG. 5 is an extremely magnified aerial view of the pores on a typical billboard alternative in some embodiments. The pores allow for the solvent to the adhesive to easily get under to speed up the removal process to reduce impact to traffic when a change is needed.

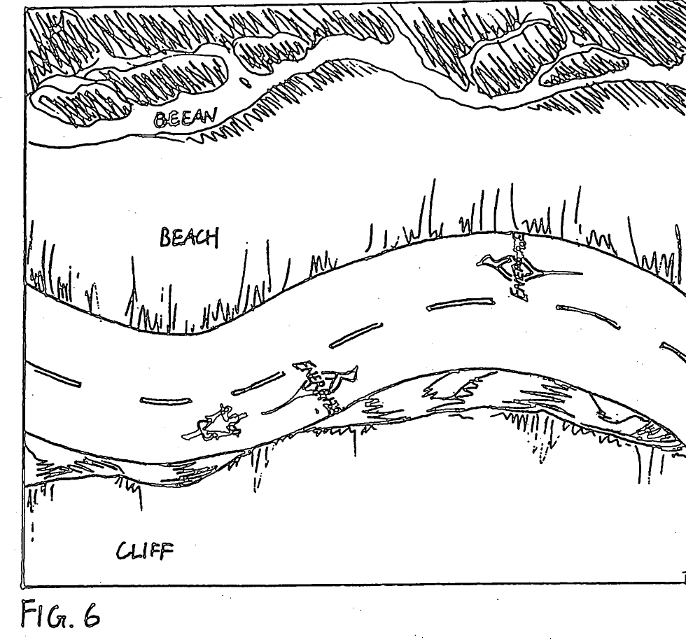

FIG. 6 is an aerial view of typical billboard alternative that are placed along the boardwalk of the California coast. Thousands of bikers, skaters, skateboarders, pedestrians, etc. travel this path daily. Sports drink beverage companies, among others are a perfect match for this type of advertising area.

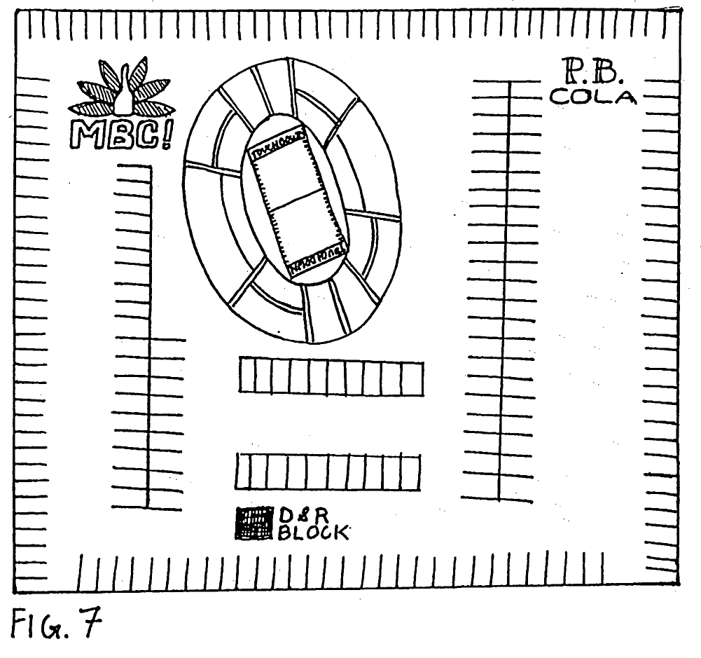

FIG. 7 is an aerial view of a stadium with a few billboard alternative of the events sponsors' logo on the ground. When the news cameras cover, for instance, large sporting events from the sky as they always do, the advertisers will have their billboard alternative shown on television. This will be a great form of advertising and revenue during such profit-earning events.

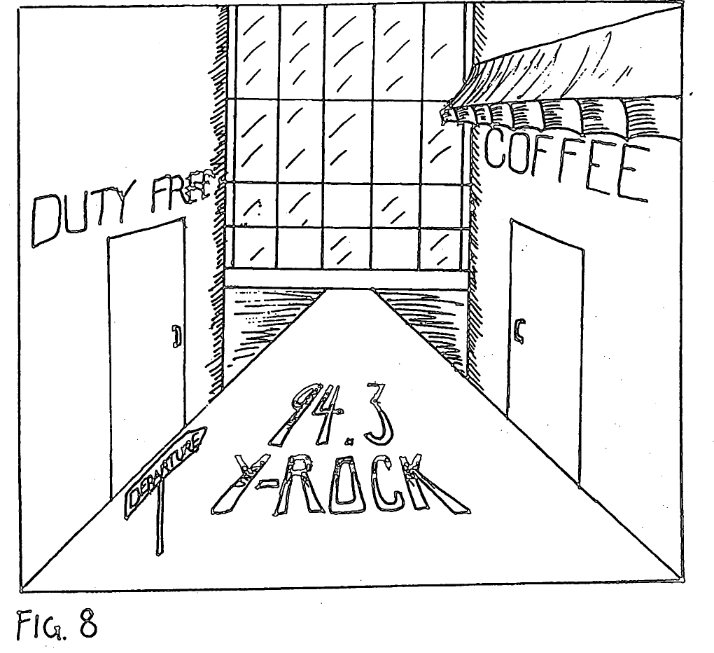

FIG. 8 is a lateral view of the billboard alternative located inside a terminal of an airport. Thousands of people depart and arrive from airports all over the world, everyday, and the airport terminals will be a hot spot for advertising with the billboard alternative.

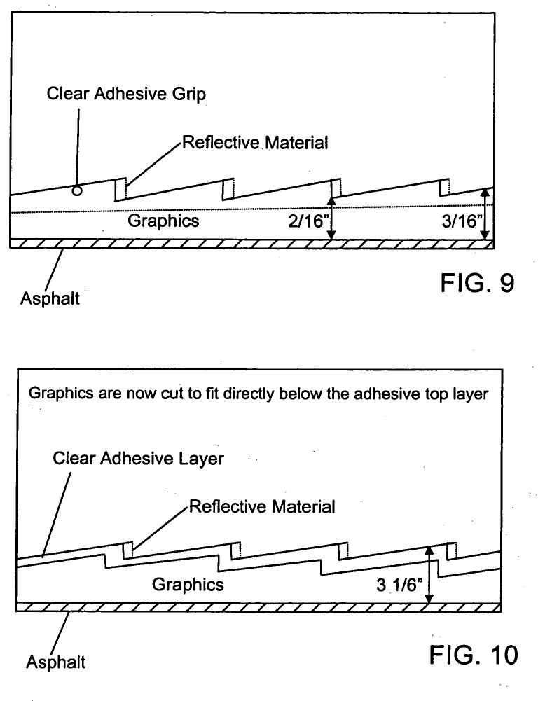

FIGS. 9 and 10 show a preferred method and materials for the billboard alternative. FIG. 9 shows a magnified close look at the billboard alternative, revealing that there are three layers. A bottom layer is asphalt (or other floor/ground space) with a thin, bright ad directly above it. The thin ad layer involves graphics, depicting advertising graphics for example. In some embodiments the ad layer is made from a very thin vinyl. An overlay layer substantially overlays the ad layer, and in some embodiments completely overlays the ad layer. The overlay layer as illustrated in the embodiment of FIG. 9 is a clear material, plastic in some embodiments, slightly jagged upper surface. The jagged, or saw tooth, upper surface which provides a slip resistant function, as well as a reflective function. In some embodiments the slightly jagged top surface of the overlay layer includes surfaces somewhat horizontal surfaces largely forming an acute angle with respect to the roadway, interspersed with somewhat vertical surfaces forming largely obtuse angles with the roadway. The acute surfaces, in some embodiments and as illustrated in FIG. 9, include reflective material.

The effect is believed best achieved by having the top layer be a total of 3/16 inches in height, with the lowest point at the jagged edge being ⅛ inches in height. FIG. 10 shows the same materials and method as above, but during the application process, the vinyl ad also has a jagged upper surface so that the ad is pushed up under the 1/16 inch lips of the top layer for better viewing.

Using the billboard alternative is similar to a giant sticker. The material of the billboard alternative in many embodiments is extremely durable, does not peel or lift, is slip resistant, can be made using all of the colors, shapes, etc., is easily removable, and reusable in some embodiments. Advertisers, private and public corporations, governmental and non-governmental organizations, individuals, etc. can benefit from the billboard alternative as a new, safer advertising medium. The billboard alternative is made by printers, creating an advertisement that easily adheres to pavement, roads, parking garages, bikeways, walkways, sidewalks, etc. without the chance of lifting, peeling, or fading. Billboard alternative placement engineers go out to the specified advertisement locations and adhere the billboard alternative to the pavement quickly and efficiently for the duration of the said contract between the parties involved in the advertisement. At the end of the contract, or possibly if the same advertiser would like to change its billboard alternative advertisement regularly, the billboard alternative engineers go out, roll solvent out onto the billboard alternative so that the solvent seeps into the billboard alternative's pores and dissolves the adhesive for easy removal. At that time, the billboard alternative engineers will replace the old billboard alternative advertisement and replace it with the new one.

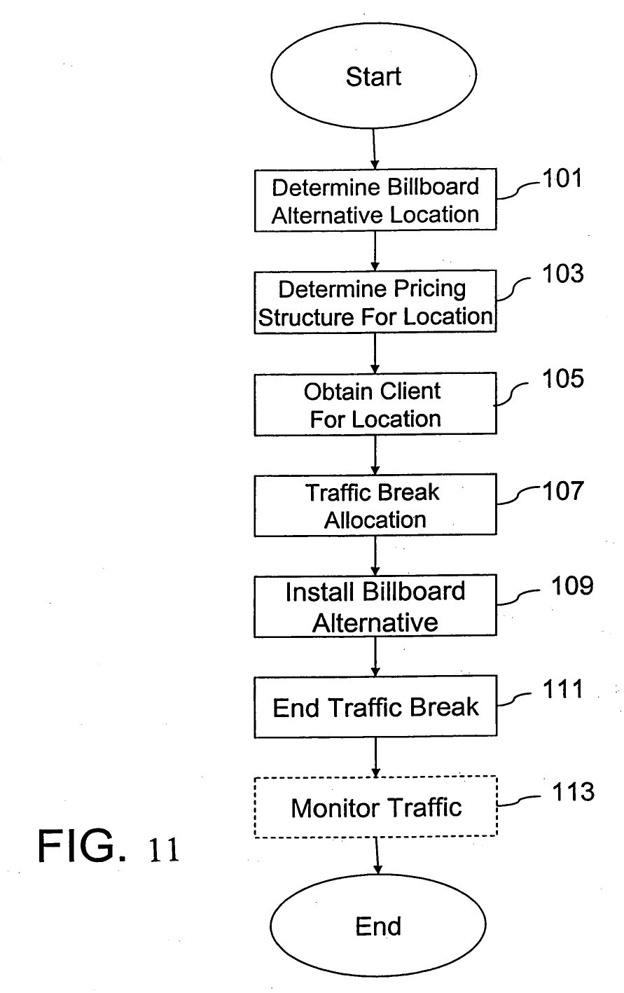

In some embodiments the process of FIG. 11 is used in connection with the above alternative. In block 101 a location for a billboard alternative is determined. The location is, in some embodiments, on a route of travel, including vehicular routes of travel. In block 103 a pricing structure for the location is determined. The pricing structure may come, for example, be based on numbers of persons or vehicles using the route of travel. In block 105 a client is obtained for the location. In block 107 a traffic break is formed at the location. The traffic break prevents traffic, such as vehicular traffic, from moving over the location. In block 109 a billboard alternative is installed at the location. In block 111 a traffic break is ended.

In some embodiments pricing for the billboard alternative at the location may be based on events subsequent to placement of the billboard alternative at the location. For example, pricing may be based on a number of vehicles using the traveled route, and variations thereof to account for times at which the billboard alternative is not visible due to very heavy traffic. Accordingly, in block 113 traffic over the travel route is monitored.

Although the invention has been described as certain embodiments, it should be recognized that the invention includes the claims and their equivalents appended hereto.

What is claimed is:

1. For an advertising system in which advertisements are placed on a ground surface such as a road, a printable material comprising:
a substantially flat material, the flat material being porous, thereby allowing a solvent to get under the flat material to dissolve an adhesive adhering the flat material to a surface.

2. The printable material of claim 1 further comprising:
an overlay layer of a clear material having a jagged surface.
